(19) United States
(12) Patent Application Publication
(10) Pub. No.: US 2009/0306967 A1
(43) Pub. Date: Dec. 10, 2009

(54) Automatic Sentiment Analysis of Surveys

(75) Inventors: Nicolas NICOLOV, Boulder, CO (US); William Allen TUOHIG, Boulder, CO (US); Richard Hansen WOLNIEWICZ, Longmont, CO (US)

Correspondence Address: ROTHWELL, FIGG, ERNST & MANBECK, P.C., 1425 K STREET, N.W., SUITE 800, WASHINGTON, DC, 20005, US

(73) Assignee: J.D. POWER AND ASSOCIATES, Westlake Village, CA (US)

(21) Appl. No.: 12/481,398

(22) Filed: Jun. 9, 2009

Related U.S. Application Data
(60) Provisional application No. 61/059,997, filed on Jun. 9, 2008.

(51) Int. Cl. G06F 17/27

(52) U.S. Cl. 704/9

(57) ABSTRACT

In one aspect, the invention provides apparatuses and methods for determining the sentiment expressed in answers to survey questions. Advantageously, the sentiment may be automatically determined using natural language processing. In another aspect, the invention provides apparatuses and methods for analyzing the sentiment of survey respondents and presenting the information as actionable data.

### CROSS-REFERENCE TO RELATED APPLICATIONS

This application claims the benefit of U.S. Provisional Application No. 61/059,997, filed Jun. 9, 2008, incorporated by reference in its entirety.

### BACKGROUND OF THE INVENTION

1. Field of Invention

The present invention relates to methods for automatically analyzing answers to survey questions. More specifically, in one aspect the invention relates to analyzing answers to predetermined questions to determine sentiment. In another aspect, the invention relates to aggregating and visualizing the results of the sentiment analysis.

2. Discussion of the Background Art

Measuring, analyzing, and monitoring the views, sentiments, and opinions of groups can be of great importance to many industries. For example, retailers or marketing agencies may wish to determine opinions of buyers on particular products, on a company's brand, on a new design, and the like.

One approach for acquiring group opinion data is to directly query members of the group. For example, one may pose to the constituents of the group a plurality of questions (i.e., a survey) focused on one or more products, issues, etc. (e.g., by distributing a prepared survey). Surveys are typically administered via person-to-person contact, over a telephone, or in writing (e.g., vial mail or distributed papers). As Internet access continues to become a more widespread and integral part of daily life, surveys are increasingly administered via the World Wide Web.

Performing analysis of survey results is often inaccurate and inefficient. For example, in a traditional in-person or online survey, focus group, or direct/e-mail survey, it may take months before analysis is complete and a final report is issued to an interested client or sponsor of the survey. A substantial amount of human labor is typically required to convert natural language responses into more useful quantitative data and this conversion process does not typically lend itself to simple machine automation. Furthermore, it is often desirable to aggregate the opinions of multiple group constituents (e.g., determine an “average opinion”), which may be difficult, even for human analysts, when the survey responses are natural language responses.

These difficulties may be alleviated by using surveys that are limited to accepting predetermined answer choices (e.g., “Yes/No” options, numerical ranges, multiple choice, etc.). However, surveys with limited response choices often fail to assess a variety of implicit characteristics of the response or respondent that a human survey specialist could imply from the tone, content, and manner in which the response to a particular question is given. Additionally, survey responses may be influenced by the response choices provided.

### SUMMARY OF THE INVENTION

It is an object of the present invention to overcome disadvantages of the prior art by providing systems and methods for automatically determining sentiments and opinions of groups based upon natural language responses to surveys.

In accordance with a first aspect of the present invention, a method for analyzing one or more textual answers provided in response to a predetermined question includes utilizing a digital computer configured with language processing software to: (a) identify a question topic and one or more question focuses based upon the text of the question; and (b) determine an expected answer type of the question based upon at least one of the question topic, the one or more question focuses, and the text of the question. In some embodiments, the method may also comprise determining a natural language corresponding to the text of the question and utilizing software configured to process text in that natural language.

In some cases, the question topic and focus may be determined based upon identifying question topic phrases and question focus phrases, respectively, within the text of the question. Additionally, the method may also include using the question topic phrases and question focus phrases to generate answer topic phrases and answer focus phrases, respectively. Furthermore, in some embodiments the method includes generating at least one of a set of implied answer phrases and a set of semantically related answer phrases. The method may also include accepting answer phrases as user input.

In accordance with a second aspect of the present invention, a method for analyzing one or more textual answers provided in response to a predetermined question includes utilizing a digital computer configured with language processing software to: (a) identify occurrences of one or more answer topic phrases and one or more answer focus phrases within the one or more answers; and (b) perform sentiment analysis of the one or more answers. In some embodiments, the answer topic and focus phrases that are identified may be based upon question topic and focus phrases, as described above.

The method may also include the application of various natural language processing algorithms to the survey answers. For example, the method may include generating metadata annotations (e.g., paragraph identification, tokenization, sentence boundary detection, part-of-speech tagging, clause detection, phrase detection (chunking), syntactic analysis, word sense disambiguation, and semantic analysis, etc.) based upon the text of the one or more answers.

In some embodiments, semantic analysis may include at least one of: identifying occurrences within the one or more answers of mentions of semantic types corresponding to an expected answer type and resolving coreference and anaphora within the text of the one or more answers. In some cases, instances of anaphora that are unable to be otherwise resolved may be associated with the focus of the question.

The semantic analysis may also include identifying occurrences of at least one of synonyms, hypernyms, hyponyms, meronyms, and antonyms of the answer topic phrases and answer focus phrases within the one or more answers.

In some embodiments, the method may also identify occurrences of at least one of variations (e.g., abbreviations) and fuzzy character matches of the answer focus phrases and answer topic phrases within the one or more answers.

The method may further include a step of identifying subtopics of discussion within the one or more answers, e.g., by grouping at least one of paragraphs, phrases, and tokens within the one or more answers. In some embodiments, the method may adjust the identified subtopics in response to changing conditions in the question or answer data (e.g., if the question is changed or if it is administered to a different group of people). In some cases, the subtopics topics detected in the answers to one question may be used to analyze answers for a second question.

The method may perform sentiment analysis with regard to the identified answer phrases, or may perform sentiment analysis on an answer as a whole. In some embodiments, one of these alternatives may be selected for each answer based upon the number of answer phrases identified in that answer.

The sentiment analysis may include identifying occurrences of entries from a predetermined sentiment resource list, as well as identifying near matches (e.g., misspellings) of entries from the sentiment resource list. A sentiment resource may include at least one of: a list of positive and negative phrases and relative strengths of the positive and negative phrases; a list of emoticons and relative strengths of the emoticons; a list of shift phrases that strengthen or weaken relative sentiment and indicators of the strengths of the shift phrases; a list of negative indicators; and a list of modal verbs. In some embodiments, the sentiment resource list may also include required part-of-speech tags associated with one or more of the list entries. The sentiment analysis may also include negation rules for inverting the sentiment associated with a phrase that are within the scope of predetermined negation elements.

In some embodiments, the sentient analysis may include interpreting at least one of modal verbs and imperative statements as indications of negative sentiment.

In some aspects, the sentiment analysis may include considering only a subset of the answers. The subset may be selected based upon characteristics of the respondents associated with the answers (e.g., demographic characteristics).

In some embodiments, the sentiment analysis may be supplemented with audio or video data corresponding to the answers. The audio or video data may be used to determine sentiment based upon tone of voice or other social cues. In other embodiments, the sentiment analysis may be supplemented with data obtained from another source (e.g., other correspondence from the respondents). The sentiment data may also be supplemented with sentiment information obtained from another source (e.g., customer support center call records).

The method may also include steps of: (c) aggregating the sentiment analysis of the one or more answers; and (d) grouping the aggregated sentiment analysis based upon one or more common characteristics (e.g., demographic characteristics of the respondents, creation times of the answers, etc.). In some embodiments, the group sentiments of the different groups may be compared and contrasted.

In accordance with a third aspect of the present invention, a computer implemented method for analyzing one or more textual answers provided in response to a predetermined question includes utilizing a digital computer configured with language processing software to: (a) perform sentiment analysis of the one or more answers; and (b) identify one or more complaints based upon phrases contained in portions of the one or more answers having negative sentiment. The method may also include identifying one or more complaints from a subset of the one or more answers wherein the respondents providing the subset of the one or more answers share one or more demographic characteristics. The complaints may be identified by grouping phrases that occur in the answers (e.g., by head nouns) and, for example, ranking the grouped phrases based upon the frequency of occurrence of the phrase within the one or more answers. Furthermore, the method may comprise identifying positive features in a group opinion based upon phrases contained in portions of the one or more answers having negative sentiment.

In accordance with a fourth aspect of the present invention, a computer implemented method of analyzing one or more textual answers provided in response to a predetermined questions includes utilizing a digital computer configured with language processing software to: (a) determine at least one of: the sentiment of the one or more answers, the number of answers that discuss a specified topic, and the one or more focus areas semantically within the topic; and (b) generate a chart that graphically represents the results from step (a).

In a case where the analysis includes performing sentiment analysis of the one or more answers, the chart may include a graph symbol to indicate each of one or more topics of discussion identified within the answers, wherein the size of the graph symbol and the symbol's position along one axis is correlated with the number of answers associated with the symbol's topic, and the symbol's position along a second axis is correlated with the sentiment associated the symbol's topic.

In a case where the analysis includes determining the number of answers that discuss a specified topic, the chart may include a first axis correlated with time periods, a second axis correlated with a number of answers, and one or more symbols indicating the number of answers that discuss the specified topic at each time period.

In a case where the analysis includes determining the number of answers that discuss a specified topic and one or more focus areas semantically within the topic, the chart may include a first axis correlated with each focus, a second axis correlated with a relative percentage of answers that discuss a focus in relation to a number of answers that discuss any focus within the topic, and one or more symbols indicating the relative portion of answers that discuss the topic which also discuss each of the focus areas.

The present invention is advantageous in that is can take into account the tone, content, and manner of making a response in determining sentiment and can reduce the time and effort involved in converting natural language responses into quantitative data.

Other objects and advantages of the present invention will be apparent to those of skill in the art upon review of the following detailed description of the preferred embodiments of the invention and the accompanying drawings.

### BRIEF DESCRIPTION OF THE DRAWINGS

The accompanying drawings, which are incorporated herein and form part of the specification, illustrate various embodiments of the present invention and, together with the description, further serve to explain the principles of the invention and to enable a person skilled in the pertinent art to make and use the invention. In the drawings, like reference numbers indicate identical or functionally similar elements.

FIG. 1 is a schematic diagram illustrating a system for automatic sentiment analysis according to the present invention.

FIG. 2 is a flow chart illustrating a process for automatic sentiment analysis according to the present invention.

FIG. 3 is a cluster graph of sentiment versus volume of discussion on a given topic according to the present invention.

FIG. 4 illustrates a line graph representing the volume of discussion on a particular topic over time according to the present invention.

FIG. 5 illustrates a bar graph showing the number of occurrences of focus phrases in the answers according to the present invention.

### DETAILED DESCRIPTION

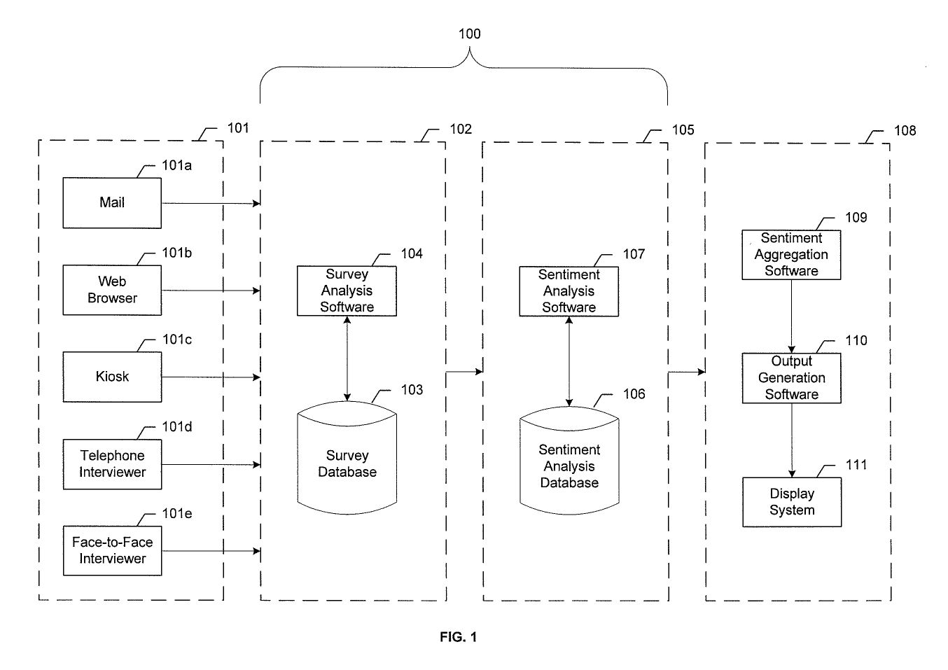

FIG. 1 is a schematic diagram illustrating data flow in a system 100 for automatic sentiment analysis of surveys according to one aspect of the present invention. As illustrated in FIG. 1, input to the system 100 may consist of survey results (i.e., answers to one or more predetermined questions) from one or more sources 101. For example, survey results may be received via mail or other correspondence 101a, via web browsers 101b, via a kiosk or terminal 101c, via telephonic survey 101d, via face-to-face interview 101e, or any combination of the foregoing data sources. Furthermore, embodiments of the invention are not limited to these data sources and aspects of the invention may be applied to any question and answer data obtained by alternate means.

The survey results may be input to a survey analysis system 102. The survey analysis system 102 may be configured to perform natural language processing on the survey questions and answers. In some embodiments, the survey analysis system 102 may comprise a digital computer having a data processing system (e.g., a microprocessor, an application specific integrated circuit (“ASIC”), a field programmable gate array (“FPGA”), etc.) and a data storage system (e.g., an electronic memory, hard drive, optical disc drive, etc.). The survey analysis system 102 may comprise a survey database 103 stored on the data storage system configured to store the survey questions and answers provided by the sources 101. In some embodiments, the survey analysis system 102 may also comprise survey analysis software 104 stored in the data storage system that, when executed by the data processing system, performs natural language processing on the questions and answers. In other embodiments, the survey analysis system 102 may comprise one or more ASICs or FPGAs configured to perform natural language processing without requiring additional software.

The survey analysis system 102 may provide the survey results to a sentiment analysis system 105. The sentiment analysis system 105 may be configured to determine the sentiment of survey answers and from this information determine the group sentiment of the survey participants. In some embodiments, the sentiment analysis system 105 may comprise a digital computer having a data processing system (e.g., a microprocessor, an application specific integrated circuit (“ASIC”), a field programmable gate array (“FPGA”), etc.) and a data storage system (e.g., an electronic memory, hard drive, optical disc drive, etc.). The sentiment analysis system 105 may comprise a sentiment analysis database 106 stored on the data storage system configured to store sentiment resource lists and sentiment analysis results. In some embodiments, the sentiment analysis system 105 may also comprise sentiment analysis software 105 stored in the data storage system that, when executed by the data processing system, performs sentiment analysis on the questions and answers. In other embodiments, the sentiment analysis system 105 may comprise one or more ASICs or FPGAs configured to perform sentiment analysis without requiring additional software.

The results of sentiment analysis may be provided to a sentiment reporting system 108. The sentiment reporting system 108 may be configured to aggregate the results of the sentiment analysis into quantitative data describing group opinions. The sentiment reporting system may also be configured to generate one or more graphical representations of the sentiment analysis. In some embodiments, the sentiment reporting system 108 may comprise a digital computer having a data processing system (e.g., a microprocessor, an application specific integrated circuit (“ASIC”), a field programmable gate array (“FPGA”), etc.) and a data storage system (e.g., an electronic memory, hard drive, optical disc drive, etc.). The sentiment reporting system 108 may comprise sentiment aggregation software 109 stored in the data storage system that, when executed by the data processing system, aggregates the results of the sentiment analysis to determine group opinion information. The sentiment reporting system 108 may further comprise output generation software 110 stored in the data storage system that, when executed by the data processing system, generates one or more graphical representations of the aggraded sentiment information. In other embodiments, the sentiment analysis system 105 may comprise one or more ASICs or FPGAs configured to perform sentiment analysis without requiring additional software. The sentiment aggregation system 108 may also include a display system (e.g., a cathode ray tube, liquid crystal display, organic light emitting diode display, printer, plotter, etc.) for displaying the graphical representations to a user of the system 100.

In some embodiments, the survey analysis system 102, the sentiment analysis system 105, and the sentiment reporting system 108 may comprise a single digital computer having shared resources. Furthermore, the division of functions between the survey analysis system 102 and the sentiment analysis system 105 as described below is primarily for illustrative purposes and should not be construed to limit the invention. The various functions described hereinafter may be divided in a different manner than described without departing from the scope of the current invention.

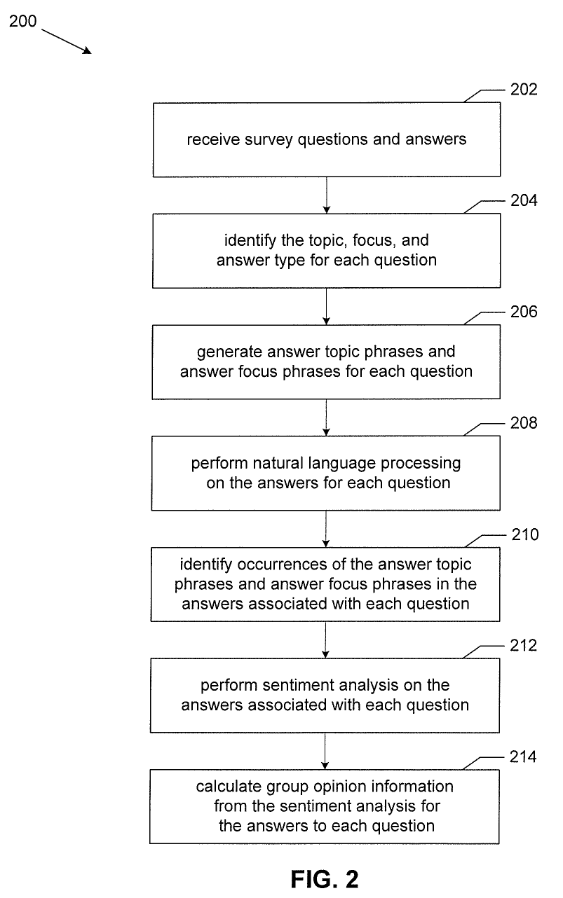

FIG. 2 is a flow chart illustrating a process 200 for automatically determining sentiments and opinions of groups based upon natural language responses to surveys according to another aspect of the invention. Process 200 may begin at step 202 when the survey processing system 102 receives survey results from one or more sources 101. In some embodiments, the survey results may comprise both the survey questions and answers provided by survey participants.

At step 204, the survey analysis system 102 may use natural language processing to determine a “topic,” “focus,” and “expected answer type” for each question. For example, if a question is “What is the weight of your new Audi car?” the topic may be “your new Audi car,” while the focus may be “weight.” (As used hereinafter, a “phrase” may consist of a single word or multiple words. For example, “your new Audi car” may be referred to as a “topic phrase,” while “weight” may be referred to as a “focus phrase.”) Furthermore, the expected answer type may be identified as a “measure.” The survey analysis system 102 may determine the expected answer type based upon textual analysis of at least one of the question, the topic, and the focus (e.g., by using predetermined heuristics or statistical approaches). For example, if the question text is “How long . . . ” the expected answer type may be “duration.”

In some embodiments, the survey analysis system 102 may determine the natural language of each question before identifying the topic, focus, and answer type of the question. After determining the natural language of a question, the survey analysis system 102 may use survey analysis software configured to process that natural language. This may include executing different software based upon the natural language of the question or executing general software using resources specific to the language.

The topic and focus phrases identified at step 204 may be used to guide the analysis of the answers. For example, at step 206, the survey analysis system 102 may generate answer topic phrases and answer focus phrases based upon the question topic and focus phrases. Answer topic phrases and answer focus phrases may be used as “anchors” within the text of an answer for performing natural language processing and sentiment analysis, as will be described hereinafter.

In some embodiments, the answer phrases may be the same as the question phrases. In other embodiments, the answer phrases may be suitably modified so that they will be likely to occur within the answers. For example, if the topic phrase in the question is “your vehicle,” some answer topic phrases may be “my vehicle,” “our vehicle,” “that vehicle,” etc. Furthermore, in some embodiments the answer topic phrases and answer focus phrases may be used to create topic and focus templates. For example, if an answer phrase is “my vehicle,” a corresponding template may be “my-MODIFIER-vehicle.” This answer template may match modified versions of the answer phrase (e.g., “my new vehicle,” “my favorite vehicle,” “my used vehicle,” etc.).

Additionally, the survey analysis system 102 may generate implied answer phrases based upon the answer phrases already generated.

Furthermore, in some embodiments a user of the survey analysis system 102 may provide additional answer phrases using data entry mechanisms known in the art (e.g., keyboard driven data entry, graphical user interfaces, etc.).

In some embodiments, the survey analysis system may further expand the set of answer phrases using word ontologies (e.g., WordNet) to determine answer phrases including: synonyms, hypernyms (i.e., broader concepts), hyponyms (i.e., narrower concepts), antonyms, and meronyms (i.e., sub-parts) of the answer phrases. In some cases, relatively longer answer phrases may be expanded by dividing the phrase into smaller phrases or by basing the expansion upon only the head noun of the phrase.

At step 208, the survey analysis system may perform natural language processing on the answers. In some embodiments, the natural language processing may be used to annotate the answer text with metadata, including at least one of: paragraph identification; tokenization; sentence boundary detection; part-of-speech tagging; clause detection; phrase detection (chunking); syntactic analysis; word sense disambiguation; semantic analysis.

In some embodiments, the survey analysis system 102 may determine the natural language of each answer before identifying the topic, focus, and answer type of the answer. After determining the natural language of an answer, the survey analysis system 102 may use survey analysis software configured to process that natural language. This may comprise executing different software based upon the language of the answer or executing general software using resources specific to the language.

Natural language processing of an answer may also include identifying phrases of semantic types corresponding to the expected answer type. For example, in a case where the question may be: “Which associate impacted your shopping experience most?” the expected answer type may be “person.” This expected answer type may match names (e.g., “John Smith”) and pronouns (e.g., “he”) in the text of the answers. E.g.:“[(person) John Smith] was great! [(person) He] helped me enormously.”

Natural language processing of an answer may also include resolving coreference and anaphora within the answer text. This may comprise grouping proper nouns, pronouns, and nominal phrases together if they refer to the same entity. For example, in a case where the answer text is “[(person) John Smith] was great! [(person) He] helped me enormously,” “John Smith” and “He” refer to the same entity and may be grouped together. In addition, any anaphoric elements that are not resolvable within the context of an answer may be associated with the question focus (or synonyms thereof if compatible by syntactic gender, number, semantic characteristics, etc.).

In some embodiments, the survey analysis may also include detection of subtopics of discussion within the answers. This may comprise clustering the answers, paragraphs or phrases within the answers, or individual tokens (e.g., words). Clustering techniques such as k-means clustering, agglomerative clustering, topic modeling, etc. may be utilized. The subtopics may be updated as the survey data changes over time (e.g., if a survey is administered at different times, if questions are added to or removed from the survey, etc.). In some cases, the subtopics may be used to subdivide the survey results based upon survey respondents that discussed a particular subtopic or answers that discussed a particular subtopic. Furthermore, the subtopics from one set of survey results may be used to analyze the results of a separate survey.

At step 210, the sentiment analysis system 105 identifies occurrences of the focus and topic phrases and the phrases derived therefrom (e.g., modified phrases, phrase templates, implied phrases, synonyms, hypernyms, hyponyms, antonyms, meronyms, etc.) in the answer text. In some embodiments, this may also include identifying occurrences of variations of the answer phrases (e.g., abbreviations, initialisms, acronyms, misspellings, etc.). Furthermore, in some embodiments this may comprise identifying occurrences of the answer phrases using fuzzy character matching.

At step 212, the sentiment analysis system 105 uses the survey data, natural language processing information, and answer phrases to determine the sentiment expressed in the answers toward a topic or focus. The sentiment analysis may be used to calculate a numerical score, a category (e.g., “positive,” “very positive,” “negative,” “very negative,” etc.), a confidence or probability (“80% likelihood of positive,” etc.), or some other form of objective data reflecting the sentiment of the answer. In some embodiments, a combination of these may be used (e.g., “very positive with a 90% confidence,” etc.). The score, category, and confidence levels may be stored in association with the answer for subsequent analysis, or may be used on-the-fly for accumulating aggregate information.

Based on the number of phrase occurrences identified in step 210, the sentiment analysis system 105 may determine whether to determine the sentiment of the answer as a whole or to perform sentiment analysis of the individually identified answer phrases (i.e., anchors).

The sentiment analysis at step 212 may utilize predetermined sentiment resource lists, which may include:
1. A list of predetermined positive and negative phrases. The list of positive and negative phrases may also comprise a strength indicator associated with each list entry that reflects how strongly the positive or negative phrase expresses sentiment. For example “dislike” may indicate only mild negative sentiment, while “hate” may indicate much stronger negative sentiment. The relative strengths of the positive and negative phrases may comprise categories, a numerical score, etc.
2. A list of emoticons (i.e., textual portrayal of a writer's mood). The list of emoticons may also comprise indications of whether the emoticon expresses positive or negative sentiment, and a strength indicator associated with each list entry that reflects how strongly the emoticon expresses sentiment. For example, the“:)” emoticon may represent mild positive sentiment, while the “=D” emoticon may represent stronger positive sentiment.
3. A list of shift phrases that strengthen or weaken the relative sentiment of a phrase (e.g., “very,” “slightly,” “sometimes,” etc.). The list of shift phrases may also comprise a modulation indicator associated with each list entry. The modulation indicator may correspond to the relative strength of the shift phrase (i.e., how much does the shift phrase affect the underlying sentiment). For example, “extremely” may modulate sentiment more significantly than “very.” The modulation indicator may comprise categories, a numerical score, etc.
4. A list of negation indicators that invert the sentiment of a phrase (e.g., “not,” “without,” “non-*,” “un-*,” etc.).
5. A list of modal verbs that alter the sentiment of a phrase (e.g., “could,” “should,” etc.). The list of modal verbs may also comprise modal constructions (e.g., “it would be,” etc.). In some embodiments, the sentiment analysis may regard modal verbs and modal constructions as indications of negative sentiment.

Furthermore, in some embodiments, one or more of the resource lists may also comprise part-of-speech tags associated with the tokens (e.g., words) within the phrases. For example, in a case where a positive phrase may be “like,” the part-of-speech tag may require that the word like function as a verb. Compare “I like my new vehicle” (like is a verb, indicating positive sentiment) with “a raven is like a writing desk” (like is a preposition, and ambiguous with regard to sentiment). In cases where the phrases comprise more than one token, part-of-speech tags may be associated with all or some of the tokens.

The sentiment analysis may comprise identifying occurrences of the sentiment resources within the answers. If a sentiment resource includes one or more part-of-speech tags, the part-of-speech tags may be compared with part-of-speech tags for the answers that may have been generated at step 208 in order to verify an occurrence of the sentiment resource. In some cases, the sentiment analysis may also comprise identifying occurrences of misspellings of the sentiment resources (e.g., “liek” may correspond with “like,” “corteos” may correspond with “courteous,” etc.).

The sentiment analysis may also include the application of local and global negation rules. The application of local and global negation rules may comprise: (1) determining the scope of the negation indicator; and (2) applying a function on the current sentiment value determined for that scope. For example, if the sentiment within the scope of the negation element would otherwise be positive, the negation rule may result in a negative sentiment (e.g., “not a good vehicle” expresses negative sentiment). On the other hand, if the sentiment within the scope of the negation element would otherwise be negative, the negation rule may result in a positive sentiment (e.g., “not a bad vehicle” expresses have a positive sentiment). Additional aspects related to some embodiments of the invention are disclosed in Nicolov et al., “Sentiment Analysis: Does Coherence Matter?” Symposium on Affective Language in Human and Machine, AISB 2008 Convention, Apr. 1-2, 2008, incorporated herein by reference.

In some embodiments, the sentiment analysis may regard imperative constructions (e.g., “Stop overcharging clients”) as indications of negative sentiment regardless whether the sentiment within the scope of the imperative construction would otherwise be positive or negative. The sentiment analysis may determine than an answer contains an imperative construction by checking an initial token and ensuring its part-of-speech tag is appropriate (e.g., infinitive verb).

The sentiment analysis may be restricted to determine the sentiment of a subset of survey respondents. The subset of survey respondents may be selected based upon explicitly available information (e.g., respondents that answered one or more survey questions in a predefined way). For example, if a brand wishes to determine public sentiment regarding a product among people who do not own the product, the survey may include a question “Do you own the product?” and a subset may be selected based upon survey respondents that answered that question in the negative. Alternately, the subset may be selected based upon inferred information from the respondents' answers (e.g., phrases, subtopics discussed, sentiment on subtopics, etc.), or on a combination of explicit and inferred information.

In some embodiments, the survey results may be acquired from spoken text (e.g., from telephone administered surveys). In such cases, sentiment analysis may also determine sentiment based upon the audio signal of the answer (e.g., tone of voice, inflection, speed, etc.).

In some embodiments, the sentiment analysis may also incorporate other information about survey respondents. For example, the sentiment analysis may incorporate previous communications with the respondent (e.g., emails that the respondent had previously sent to a customer service department), previous transactions with the respondent, other content generated by the respondent (e.g., a website or web log), etc.

After the sentiment of the answers is complete, the sentiment analysis system 105 may determine group opinion information representing the aggregate sentiment of the survey respondents (step 214). In some embodiments, this may include analyzing a structure of the question space and determining equivalencies between questions. For example, sentiment analysis system 105 may be used to analyze different surveys over a period of time it may occur that two questions are sematically equivalent (i.e., ask the same thing) but are worded differently. Additionally, a same questions may be asked in different languages (English, French, etc.).

In some embodiments, the sentiment analysis may be grouped according to characteristics of the questions. For example, the questions may be organized into a question hierarchy based upon their semantic relationships (e.g., questions about a vehicle's price, questions about a vehicle's reliability, and questions about a vehicle's performance may all be semantically grouped as questions about the vehicle). In this case, the results of the sentiment analysis may also be aggregated according to the same hierarchy (e.g., a single sentiment score for the topic “vehicle” comprising an aggregate of the sentiment scores for the topic/focus pairs “vehicle/price,” “vehicle/reliability,” and “vehicle/performance”) sentiment analysis may group sentiment results based upon the gender or age of the respondent. (including the ‘Unique Question Group Identifier’ as well as the groups of questions in the ‘Questions Hierarchy’). This analysis refers to a single user group and single question group.

In addition, in some embodiments the sentiment analysis may be grouped based upon characteristics of the survey respondents. The survey results may be divided into groups based upon values of a characteristic. For example, the answers may be grouped into those provided by female respondents and those provided by makle respondents, where the characteristic is “gender.” In addition, the answers may be grouped by values of different characteristics. For example, the answers may placed in a first group of those provided by female respondents who are not smokers, and a second group of respondents from California with three children. The answers may also be grouped based upon question groupings, or the time at which the answers were provided.

In some embodiments, the sentiment analysis system 105 may keep track of the sentiment of an answer group over time. This may include analyzing answers provided by the same group of respondents or, alternately, answers from respondents that may share one or more character tics of the first group of respondents (e.g., both groups may be male).

The sentiment analysis system 105 may also be configured to perform sentiment analysis with regard to a topic or focus not specified in the question. For example, a user of the system may specify additional anchor phrases using data entry mechanisms known in the art (e.g., keyboard driven data entry, graphical user interfaces, etc.).

In some embodiments, the sentiment analysis system 105 may also be configured to aggregate answers to questions with predetermined answer choices as sentiment information determined from natural responses. In some embodiments, the sentiment analysis system 105 may be configured to aggregate survey answers several different natural languages.

In one aspect, the invention may be used to identify prominent unmet needs, issues, or complaints, based upon phrases that were identified as expressing negative sentiment in the answers. For a more focused analysis, the answers may be restricted to a particular question (or group of equivalent questions), or to answers provided by a group of respondents sharing common characteristics (e.g., gender, geographic location, etc.). In some embodiments, phrases matching predetermined patters may also be identified for this feature (e.g., “Company X could do better at <ISSUE>”).

In some embodiments, the identified phrases may be generalized by merging occurrences of phrases. For example, phrases may be merged if they share a head noun, if the phrases or their head nouns are synonyms, or if the phrases or their head nouns share hypernym. The degree of merging (i.e., the minimum threshold of relative similarity between phrases to merge) may be automatically determined or manually specified by an analyst using the system. For example, system may be configured to perform no merging, to group phrases when they share a head noun, to group phrases when they share a semantic sense, to group phrases if they share a hypernym via N degrees of semantic concepts. The system may use different levels of merging for different phrases, based upon the semantic distances between the phrases. In some embodiments, the phrases may be clustered using soft or hard clustering, flat (e.g., k-means clustering) or hierarchical clustering (e.g., agglomerative clustering).

The phrases (or phrase groups) may be assigned a rank score. In some embodiments, the rank score of a phrase (or phrase group) may be calculated as:

Rank(phrase)=occurrences(phrase)·log(respondents/respondents using phrase)

A rank score based upon this equation may be similar to a term frequency—inverse document frequency (“TF-IDF”) score commonly used in information retrieval. In the above equation, occurrences(phrase) represents the total number of occurrences of the phrase (or phrase group) within the answers being considered, respondents represents the total number of respondents that provided the answers being considered, and respondents using phrase represents the total number of respondents that provided answers including the phrase (or phrase group).

In some embodiments, the system may also be used to identify prominent positive factors, based upon phrases that were identified as expressing positive sentiment in the answers.

In another aspect, the invention may be used to supplement sentiment data acquired by other means to gain an improved estimate of group opinion. For example, an embodiment of the invention may reveal that 63% of survey respondents expressed negative sentiments about opening bank accounts at a bank branch in Dallas, Tex. In addition, call center data analysis may reveal that 71% of callers expressed negative sentiments regarding the same branch. Analyzing different sources may indicate seriousness of a problem which may otherwise seem an isolated incident.

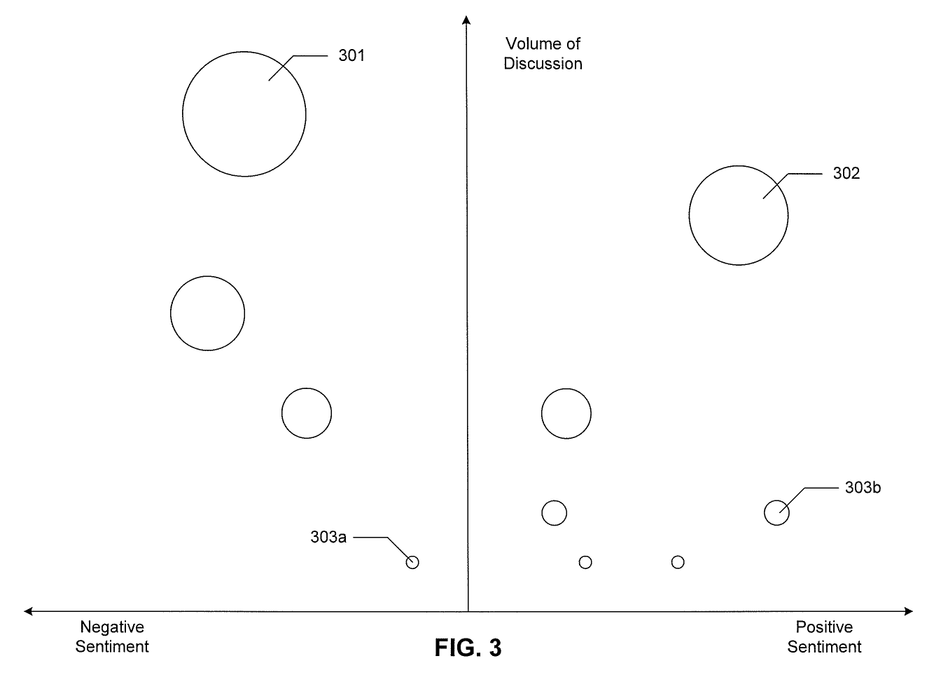

In another aspect, the invention may provide graphical or textual representations of the sentiment analysis. For example, FIG. 3 illustrates a cluster graph of attribute (or sub-topic) sentiment (x-axis) versus volume of discussion on a given topic (y-axis), generated using a system and method for sentiment analysis of survey results according to an embodiment of the present invention. The topics may be specified in the survey question, or it may be discovered, e.g., by analyzing responses to open ended questions using methods such as clustering, phrase detection, etc. Similarly, attributes may be specified or discovered. For example, the topic may be “Customer Service” and the attributes may be “Sales Staff,” “Service Department,” “Online Help,” etc. The size of each point, and its location on the y-axis of the graph, is proportional to the number of responses in a cluster relating to an attribute. The location of each point on the x-axis represents the percentage of responses in the cluster relating to the attribute that are positive.

In FIG. 3, topic clusters in the upper left quadrant (e.g., cluster 301) may indicate prominent unmet issues or complaints associated with a large amount of negative sentiment. Topic clusters in the upper right quadrant (e.g., cluster 302) may indicate prominent features associated with a large amount of positive sentiment. Topic clusters in the lower quadrants (e.g., 303a, 303b) may represent topics that do not receive much attention from the survey respondents.

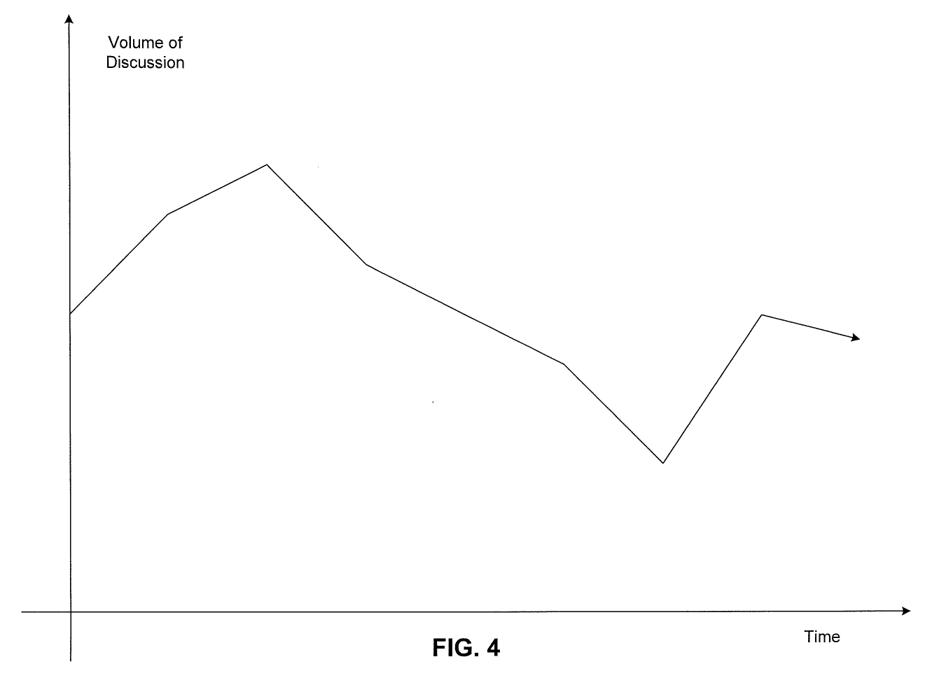

FIG. 4 illustrates a line graph representing the change in volume of discussion on a particular topic or focus detected over time. The vertical axis may represent the number of answers that mention a particular topic or focus as a percentage of all responses, and the horizontal axis may represent different points in time at which survey results were received by the system. In some embodiments, the graph illustrated in FIG. 4 may be used to determine reactions to external events, marketing campaigns, etc.

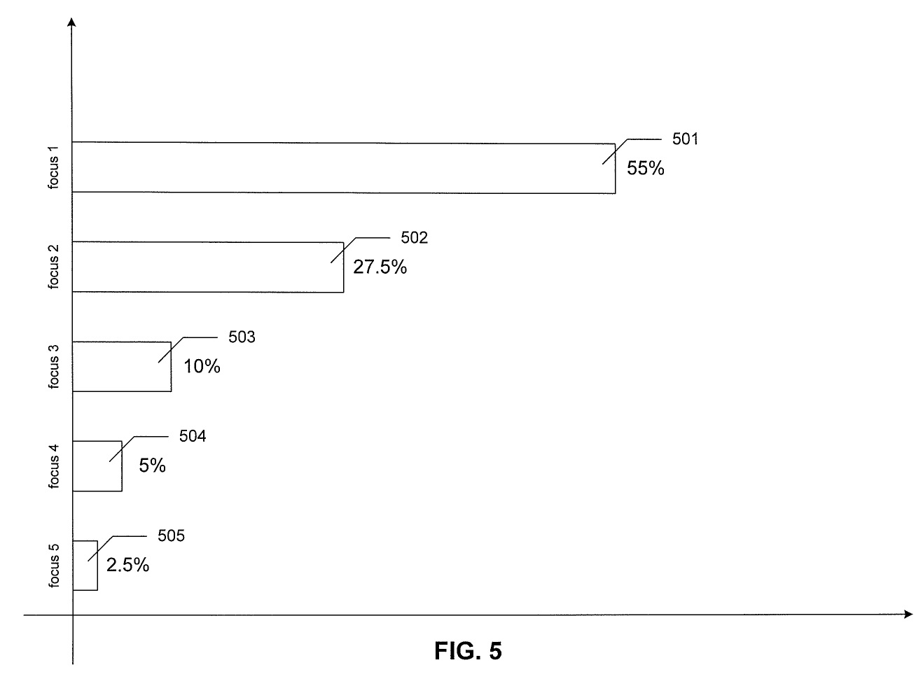

FIG. 5 illustrates a bar graph showing the number of occurrences of focus phrases in the answers as a percentage of all of the focus phrase occurrences for a given topic.

The systems, processes, and components set forth in the present description may be implemented using one or more general purpose computers, microprocessors, or the like programmed according to the teachings of the present specification, as will be appreciated by those skilled in the relevant art(s). Appropriate software coding can readily be prepared by skilled programmers based on the teachings of the present disclosure, as will be apparent to those skilled in the relevant art(s). The present invention thus also includes a computer-based product which may be hosted on a storage medium and include instructions that can be used to program a computer to perform a method or process in accordance with the present invention. The storage medium can include, but is not limited to, any type of disk including a floppy disk, optical disk, CDROM, magneto-optical disk, ROMs, RAMs, EPROMs, EEPROMs, flash memory, magnetic or optical cards, or any type of media suitable for storing electronic instructions, either locally or remotely. The automated sentiment analysis system and method can be implemented on one or more computers. If more than one computer is used, the computers can be the same, or different from one another, but preferably each have at least one processor and at least one digital storage device capable of storing a set of machine readable instructions (i.e., computer software) executable by the at least one processor to perform the desired functions, where by “digital storage device” is meant any type of media or device for storing information in a digital format on a permanent or temporary basis such as the examples set out above.

The computer software stored on the computer, when executed by the computer's processor, causes the computer to retrieve answers to survey questions from the survey software database or digital media. The software, when executed by the computer's processor, also causes the server to process the answers in the manner previously described.

The system can be located at the customer's facility or at a site remote from the customer's facility. Communication between the survey and sentiment analysis computers can be accomplished via a direct connection or a network, such as a LAN, an intranet or the Internet.

In one embodiment, the input to the system comprises the following database tables:
1. Answers Table;
2. User Table;
3. Questions Table.

The Answers Table may be a set of records with the following fields:
1. Unique Question Identifier;
2. Unique Person Identifier;
3. Answer Text;
   and, optionally, one or more of the following fields:
4. Answer Selection from List (e.g., as in multiple choice questions);
5. Date;
6. Time (of submitting the answer);
7. Duration (how long the user spent thinking and composing the answer);
8. Language in which the ‘Answer Text’ is written.

The Users Table may be a set of records about the survey respondents, preferably including the following fields:
1. Unique Person Identifier;
2. Name;
3. Surname;
4. Date of Birth or Age;
5. Gender;
6. Occupation;
7. Industry;
8. Income;
9. Marital Status;
10. Number of Children;
11. Residential address.

The Users Table may be omitted, but in some preferred embodiments the responses of different respondents in the ‘Answers Table’ may have different ‘Unique Personal Identifier’ values but will share the same identifier for the same respondent.

It is also possible that different users may have different fields. For example, a survey completed or filled-in by respondents in Europe may have different fields for the users than a separate survey conducted in the U.S.A. possibly on similar topics (e.g., how users perceive product XYZ which happens to be available in both the European and North American markets).

The Questions Table may be a set of records with the following fields:
1. Unique Question Identifier;
2. Question Text;
   and, optionally, one or more of the following fields:
3. Language of the Question Text;
4. Unique Question Group Identifier;
5. Domain (vertical or industry) of the question;
6. Focus Phrase of the Question;
7. Topic of the Question;
8. Answer Type.

Although the Question Text could be included in the Answers Table, having a separate Questions Table reduces data storage requirements by allowing use of the Question Identifier instead of the Question Text.

Optionally the system can use a Question Hierarchy, which may be implemented in a variety of ways. For example, one way to implement a question hierarchy is to have a table with the following fields:
1. Unique Question Group Identifier;
2. Unique Question Group Identifier of the superclass.

In such case, only the leaf nodes of the ‘Question Hierarchy’ are guaranteed to have questions associated with them. The intermediate node may or may not have questions.

The foregoing has described the principles, embodiments, and modes of operation of the present invention. However, the invention should not be construed as being limited to the particular embodiments described above, as they should be regarded as being illustrative and not as restrictive. It should be appreciated that variations may be made in those embodiments by those skilled in the art without departing from the scope of the present invention.

1. A computer implemented method of analyzing one or more textual answers provided in response to a predetermined question, comprising:
(a) utilizing a digital computer configured with language processing software to identify a question topic and one or more question focuses based upon the text of the question; and
(b) utilizing a digital computer configured with language processing software to determine an expected answer type of the question based upon at least one of the question topic, the one or more question focuses, and the text of the question.

2. The computer implemented method of claim 1, further comprising:
(c) utilizing a computer configured with language processing software to determine a natural language corresponding to the text of the question, wherein
steps (a) and (b) each include utilizing a digital computer configured with software for processing text of the natural language determined in step (c).

3. The computer implemented method of claim 1, wherein step (a) includes:
utilizing a digital computer configured with language processing software to identify one or more question topic phrases within the text of the question indicative of the topic of the question; and
utilizing a digital computer configured with language processing software to identify one or more question focus phrases within the text of the question indicative of the focus of the question.

4. The computer implemented method of claim 3, further comprising:
(c) utilizing a digital computer configured with language processing software to generate one or more answer topic phrases based upon the question topic phrases identified in step (a); and
(d) utilizing a digital computer configured with language processing software to generate one or more answer focus phrases based upon the question focus phrases identified in step (a).

5. The computer implemented method of claim 4, further comprising:
(e) utilizing a digital computer configured with language processing software to generate one or more answer topic templates based upon the answer topic phrases generated in step (c); and
(f) utilizing a digital computer configured with language processing software to generate one or more answer focus templates based upon the answer focus phrases identified in step (d).

6. The computer implemented method of claim 4, further comprising:
(e) utilizing a digital computer configured with language processing software to generate implied topic phrases based upon the question topic phrases identified in step (a) and the answer topic phrases generated in step (c); and
(f) utilizing a digital computer configured with language processing software to generate implied focus phrases based upon the question focus phrases identified in step (a) and the answer focus phrases generated in step (d).

7. The computer implemented method of claim 4, further comprising:
(e) utilizing a digital computer configured with language processing software to generate at least one of topic synonyms, topic hypernyms, and topic hyponyms based upon the question topic phrases identified in step (c); and
(f) utilizing a digital computer configured with language processing software to generate at least one of focus synonyms, focus hypernyms, and focus hyponyms based upon the question focus phrases identified in step (d).

8. The computer implemented method of claim 4, further comprising:
(g) utilizing a digital computer configured with language processing software to receive input from a user; and
(h) utilizing a digital computer configured with language processing software to generate at least one of answer topic phrases and answer focus phrases based upon the input.

9. A computer implemented method of analyzing one or more textual answers provided in response to a predetermined question, comprising:
(a) utilizing a digital computer configured with language processing software to identify occurrences of one or more answer topic phrases and one or more answer focus phrases within the one or more answers; and
(b) utilizing a digital computer configured with language processing software to perform sentiment analysis of the one or more answers.

10. The computer implemented method of claim 9, wherein
the answer topic phrases are identified based upon one or more question topic phrases contained in the question, and
the answer focus phrases are identified based upon one or more question focus phrases contained in the question.

11. The computer implemented method of claim 9, further comprising:
(c) utilizing a computer configured with language processing software to determine a natural language corresponding to the text of the one or more answers, wherein
steps (a) and (b) further include utilizing a digital computer configured with software for processing text of the natural language determined in step (c).

12. The computer implemented method of claim 9, further comprising:
(c) utilizing a digital computer configured with language processing software to generate metadata annotations based upon the text of the one or more answers.

13. The computer implemented method of claim 12, wherein generating metadata annotations includes at least one of: paragraph identification, tokenization, sentence boundary detection, part-of-speech tagging, clause detection, phrase detection (chunking), syntactic analysis, word sense disambiguation, and semantic analysis.

14. The computer implemented method of claim 12, wherein generating metadata annotations includes identifying occurrences within the one or more answers of mentions of semantic types corresponding to an expected answer type.

15. The computer implemented method of claim 12, wherein generating metadata annotations includes resolving coreference and anaphora within the text of the one or more answers.

16. The computer implemented method of claim 10, further comprising:
(c) utilizing a computer configured with language processing software to resolve coreference and anaphora within the text of the one or more answers; and
(d) utilizing a computer configured with language processing software to associate any anaphoric elements that are not resolved in step (c) with the question focus phrases or synonyms of the question focus phrases.

17. The computer implemented method of claim 9, further comprising:
(c) utilizing a digital computer configured with language processing software to identify occurrences of at least one of synonyms, hypernyms, hyponyms, meronyms, and antonyms of the answer topic phrases and answer focus phrases within the one or more answers.

18. The computer implemented method of claim 9, wherein step (a) includes identifying occurrences of variations of the answer focus phrases and answer topic phrases within the one or more answers.

19. The computer implemented method of claim 9, wherein step (a) includes identifying occurrences of fuzzy character matches of the answer topic phrases and answer focus phrases within the one or more answers.

20. The computer implemented method of claim 9, further comprising:
(c) utilizing a digital computer configured with language processing software to identify subtopics of discussion within the one or more answers.

21. The computer implemented method of claim 20, wherein step (c) includes grouping at least one of paragraphs, phrases, and tokens within the one or more answers.

22. The computer implemented method of claim 20, further comprising:
(d) in response to a change in the predetermined question, utilizing a digital computer configured with language processing software to identify subtopics of discussion within the one or more answers.

23. The computer implemented method of claim 20, further comprising:
(d) utilizing a digital computer configured with language processing software to analyze one or more answers to a second predetermined question based upon the subtopics of discussion identified in the one or more answers to the first question.

24. The computer implemented method of claim 9, further comprising:
(c) utilizing a digital computer configured with language processing software to determine the number of occurrences of answer topic phrases and answer focus phrases identified in step (b) within each answer of the one or more answers, wherein
in the case that the number of occurrences is above a threshold, step (b) comprises performing sentiment analysis of each occurrence within the answer individually; and
in the case that the number of occurrences is below the threshold, step (b) comprises performing a composite sentiment analysis the entire answer.

25. The computer implemented method of claim 9, wherein performing sentiment analysis comprises identifying occurrences of entries from a predetermined sentiment resource list within the text of the one or more answers.

26. The computer implemented method of claim 25, wherein the sentiment resource list comprises at least one of:
a list of positive and negative phrases and relative strengths of the positive and negative phrases;
a list of emoticons and relative strengths of the emoticons;
a list of shift phrases that strengthen or weaken relative sentiment and indicators of the strengths of the shift phrases;
a list of negative indicators; and
a list of modal verbs.

27. The computer implemented method of claim 25, wherein the sentiment resource list comprises one or more required part-of-speech tags associated with one or more list entries.

28. The computer implemented method of claim 25, wherein performing sentiment analysis includes identifying near match occurrences of entries from a predetermined sentiment resource list within the text of the one or more answers.

29. The computer implemented method of claim 9, wherein performing sentiment analysis includes identifying negation elements within the text of the one or more answers and inverting the inferred sentiment within a scope of the negation element.

30. The computer implemented method of claim 9, wherein performing sentiment analysis includes treating a modal verb within an answer as an indication of negative sentiment.

31. The computer implemented method of claim 9, wherein performing sentiment analysis includes treating an imperative phrase within an answer as an indication of negative sentiment.

32. The computer implemented method of claim 9, further comprising:
(c) utilizing a digital computer configured with language processing software to identify a subset of the one or more answers based upon characteristics of the respondents associated with answers in the subset, wherein
step (b) comprises performing sentiment analysis on the subset of answers.

33. The computer implemented method of claim 9, further comprising:
(c) utilizing a digital computer configured with language processing software to supplement the sentiment analysis using at least one of audio and video data associated with the one or more answers.

34. The computer implemented method of claim 9, further comprising:
(c) utilizing a digital computer configured with language processing software to supplement the sentiment analysis based upon additional information associated with the author of an answer.

35. The computer implemented method of claim 9, further comprising:
(c) utilizing a digital computer configured with language processing software to aggregate the sentiment analysis of the one or more answers; and
(d) utilizing a digital computer configured with language processing software to group the aggregated sentiment analysis based upon one or more common characteristics.

36. The computer implemented method of claim 35, wherein each of the one or more answers is associated with a respondent, and the one or more common characteristics comprise demographic attributes of the respondent.

37. The computer implemented method of claim 35, wherein each of the one or more answers is associated with a creation time at which the answer was created, and the one or more common characteristics comprise the creation times of the one or more answers.

38. The computer implemented method of claim 35, further comprising:
(e) utilizing a digital computer configured with language processing software to determine the difference in sentiment between the groups.

39. The computer implemented method of claim 9, wherein
at least one of the answer focus phrases and the answer topic phrases are not based upon phrases contained the question.

40. The computer implemented method of claim 9, further comprising:
(c) utilizing a digital computer configured with language processing software to comparing the sentiment analysis of the one or more answers with sentiment information obtained from another source.

41. A computer implemented method of analyzing one or more textual answers provided in response to a predetermined question, comprising:
(a) utilizing a digital computer configured with language processing software to perform sentiment analysis of the one or more answers; and
(b) utilizing a digital computer configured with language processing software to identify one or more complaints based upon phrases contained in portions of the one or more answers having negative sentiment.

42. The computer implemented method of claim 41, further comprising:
(c) utilizing a digital computer configured with language processing software to determine demographic characteristics of one or more authors associated with the one or more answers, wherein
step (b) comprises identifying one or more complaints from a subset of the one or more answers; and
the authors of the subset of the one or more answers share one or more demographic characteristics.

43. The computer implemented method of claim 41, further comprising:
(c) utilizing a digital computer configured with language processing software to group phrases contained in portions of the one or more answers having negative sentiment, wherein
step (b) comprises identifying complaints based upon the grouped phrases.

44. The computer implemented method of claim 43, wherein step (c) includes grouping phrases based upon the head nouns of the phrases.

45. The computer implemented method of claim 43, wherein step (c) includes grouping phrases based upon clustering.

46. The computer implemented method of claim 43, further comprising:
(d) utilizing a digital computer configured with language processing software to calculate a rank score for each of the phrase groups.

47. The computer implemented method of claim 46, wherein
the rank score of a phrase group is positively correlated with the number of occurrences within the one or more answers of a phrase in the phrase group; and
the rank score of a cluster is negatively correlated with the number of answers that include the phrase.

48. The computer implemented method of claim 41, further comprising:
(c) utilizing a digital computer configured with language processing software to identify positive features based upon phrases contained in portions of the one or more answers having positive sentiment.

49. A computer implemented method of analyzing one or more textual answers provided in response to a predetermined questions, comprising:
(a) utilizing a digital computer configured with language processing software to determine at least one of: the sentiment of the one or more answers, the number of answers that discuss a specified topic, and the one or more focus areas semantically within the topic; and
(b) utilizing a digital computer configured with language processing software to generate a chart that graphically represents the results from step (a).

50. The computer implemented method of claim 49, wherein
step (a) comprises utilizing a digital computer configured with language processing software to perform sentiment analysis of the one or more answers; and
the chart comprises a graph symbol to indicate each of one or more topics of discussion identified within the answers, wherein the size of the graph symbol and the symbol's position along one axis is correlated with the number of answers associated with the symbol's topic, and the symbol's position along a second axis is correlated with the sentiment associated the symbol's topic.

51. The computer implemented method of claim 49, wherein
step (a) comprises utilizing a digital computer configured with language processing software to determine the number of answers that discuss a specified topic; and
the chart comprises a first axis correlated with time periods, a second axis correlated with a number of answers, and one or more symbols indicating the number of answers that discuss the specified topic at each time period.

52. The computer implemented method of claim 49, wherein
step (a) comprises utilizing a digital computer configured with language processing software to determine the number of answers that discuss a specified topic and one or more focus areas semantically within the topic; and
the chart comprises a first axis correlated with each focus, a second axis correlated with a relative percentage of answers that discuss a focus in relation to a number of answers that discuss any focus within the topic, and one or more symbols indicating the relative portion of answers that discuss the topic which also discuss each of the focus areas.
